(19) United States
(12) Patent Application Publication
(10) Pub. No.: US 2014/0297376 A1
(43) Pub. Date: Oct. 2, 2014

(54) SYSTEM FOR AGGREGATED DISTRIBUTION OF PUBLIC NOTICES

(71) Applicant: Tanya Robertson, Brighton (AU)

(72) Inventor: Tanya Robertson, Brighton (AU)

(21) Appl. No.: 14/356,894

(22) PCT Filed: Nov. 9, 2012
(86) PCT No.: PCT/AU2012/001374

§ 371 Date: May 8, 2014

(30) Foreign Application Priority Data
Nov. 9, 2011 (AU) 2011904643

(51) Int. Cl. G06Q 10/10; G06Q 30/02; G06F 17/30

(52) U.S. Cl. CPC G06Q 10/10; G06F 17/30011; G06Q 30/0241
USPC 705/14.4; 705/342

(57) ABSTRACT

A data modification device; said device including computer implemented instructions for automatically modifying raw data input from a user of said device into criteria bound output; said device including an input receiving Aggregator adapted to interrogate a selection of databases; said Aggregator acting to modify said raw data input with reference to one or more relevant ones of said selection of databases; said device providing to said user output conforming to legal or other appropriate criteria.

### TECHNICAL FIELD

The present invention relates to dedicated systems and devices providing services to distributed clients of a facilitating entity and, more particularly to the modification of raw data into criteria bound formats.

### BACKGROUND

Many situations arise in which individuals and organizations require the dissemination of particular items of information. In at least some instances, for example in the case of some public notices, the information is required to be structured according to legal requirements which may differ according to different regions of legal jurisdiction.

Particularly, if the information is to be widely distributed, it becomes difficult for an individual or organisation to ascertain what the legal requirements may be.

A similar problem may arise in the case of the placing of advertisements. Generally, it will be desirable to disseminate the availability of a product or service as widely as possible, but in the case of advertisements also, an individual or organization may be unaware of the appropriate available publication media in different geographic regions and the best form in which the advertising material should be presented.

It is an object of the present invention to address or ameliorate some of the above disadvantages.

### Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### DEFINITIONS

In this specification:

“notices” include, but are not limited to, classifieds, public notices, advertisements and announcements.

### SUMMARY OF INVENTION

Accordingly in one broad form of the invention there is provided a data modification device; said device including computer implemented instructions for automatically modifying raw data input from a user of said device into criteria bound output; said device including an input receiving Aggregator adapted to interrogate a selection of databases; said Aggregator acting to modify said raw data input with reference to one or more relevant ones of said selection of databases; said device providing to said user output conforming to legal or other appropriate criteria.

Preferably said criteria bound output comprises public notices.

Preferably said criteria bound output comprises classifieds.

Preferably said criteria bound output comprises announcements.

Preferably said criteria bound output comprises advertisements.

Preferably said device includes connectivity to local and wide area communication networks.

Preferably said databases include remote databases maintained by third-party organizations; communication between said device and said databases effected over said wide area network.

Preferably said databases include local databases maintained by an operating entity of said device; communication between said local databases and said device effected over said local communication network.

Preferably said user selects a type of public notice from a selection of public notice types made available for generation by said Aggregator.

Preferably said Aggregator applies appropriate legal requirements to said raw data; said legal requirements extracted from a legal requirement rules database.

Preferably said Aggregator applies appropriate best practice requirements to said raw data; said best practice requirements extracted from a best practice requirement rules database.

Preferably said Aggregator presents to said user a selection of options and recommendations relating to content of a said public notice or advertisement.

Preferably said Aggregator presents to said user a selection of options for publishing a said public notice or advertisement.

In a further broad form of invention there is provided a device for transforming specific input data into data conforming to predetermined criteria; said device including a communication module for receiving said input data and an output module for transmission of modified said input data to a user; said device further provided with an interrogation module for data mining of relevant said predetermined criteria from selected databases.

In yet a further broad form of the invention there is provided a method of formatting raw input data into criteria bound output data conforming to legal and other requirements; said method including the steps of:

a) Receiving into an Aggregator of a data transforming device raw data from a user,

b) Analysing said data for characteristics requiring application of any of said legal or other criteria,

c) Interrogating appropriate databases containing said legal or other criteria,

and wherein said device automatically modifies said raw input data into a format conforming to said legal and other requirements.

Preferably said raw input data is data relating to public notice bound by legal requirements.

In yet a further broad form of the invention there is provided a method of producing a legally compliant public notice; said method including the steps of;

a) receiving as raw data into a digital processing device material descriptive of said public notice as provided by a user,

b) said device communicating with relevant ones of a selection of databases to establish legal criteria applicable to said material,

c) said device modifying said raw data into a draft of said legally compliant public notice,

d) said device transmitting at least a first said draft to an applicant user,

e) said device transmitting a legally compliant public notice for publication in selected media once a said draft is approved by said applicant user.

In yet a further broad form of the invention there is provided a data modification device for producing an appropriately structured advertisement; said device accepting as initial raw input subject matter related to a product or service to be advertised; said device extracting from selected databases criteria applicable to format and publication of said advertisement; said device transforming said subject matter into a said appropriately structured advertisement.

In yet a further broad form of the invention there is provided a method for producing a legally compliant public notice for a client user; said method including the steps of:
a computer implemented public notice aggregator receiving raw data input from said client user in the form of digital textual information relating to a required public notice,
said public notice aggregator analysing said textual information for key words to ascertain subject of said required public notice,
said public notice aggregator accessing one or more databases for pro forma public notices compliant with legal criteria,
said public notice aggregator inserting contextual data extracted from said raw data input into said pro forma public notice to complete said legally compliant public notice.

### BRIEF DESCRIPTION OF DRAWINGS

Embodiments of the present invention will now be described with reference to the accompanying drawings wherein:

FIG. 1 is a block diagram illustrating a typical process for dissemination of public notices according to prior art,

FIG. 2 is a block diagram of a data modification device and method according to a preferred embodiment of the invention,

FIG. 3 is a schematic of the various components constituting a preferred embodiment of the invention according to FIG. 2,

FIG. 4 is a more detailed schematic of the preferred embodiment of FIGS. 2 and 3,

FIGS. 5 and 6 are schematics of further elements of the preferred embodiment of FIG. 4.

### DESCRIPTION OF EMBODIMENTS

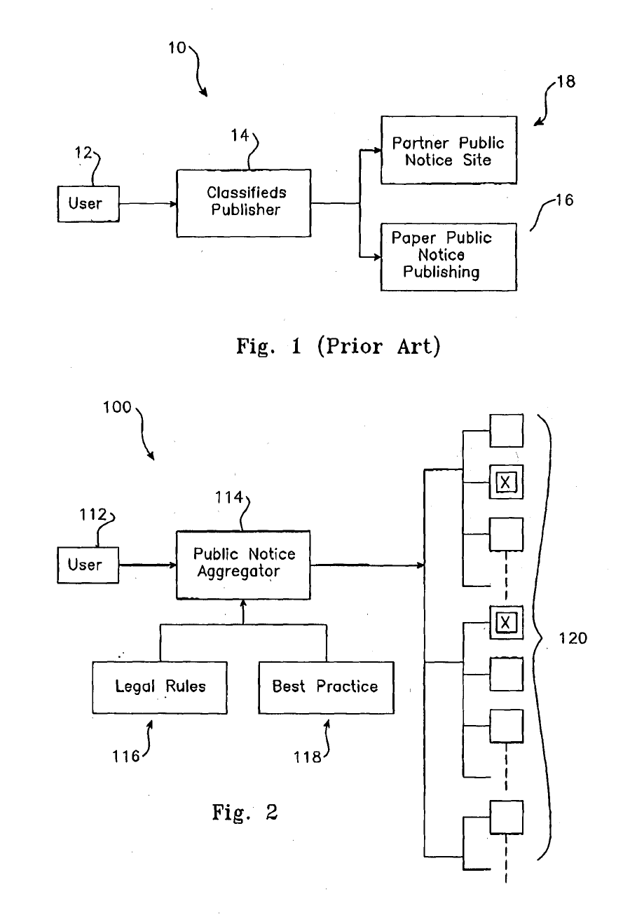

FIG. 1 shows a typical arrangement 10 for the publication of a public notice according to prior art. A user 12 composes to the best of his or her ability a notice setting out the material to be brought to the attention of the public.

The legal requirements for the publication of a public notice vary with the circumstances. For example, a notice of bankruptcy may have particular criteria for compliance whereas the form and content of a death notice is a matter of personal choice.

The quality and any compliance with legal requirements of the notice will depend on the experience and expertise of the composer, and in many cases may not meet some applicable legal requirement or fail to correctly express the necessary facts.

Once the notice is composed, an approach will be made to a classifieds publisher 14, typically a major newspaper in the area of the subject person or organization. This may or may not be sufficient to satisfy geographic legal requirements if any. Typically again, the notice will then appear in the print edition of the newspaper 16 and may additionally appear in an on-line public notice site 18.

A particular application of the device and system of the present invention is the production by the device of legally compliant public notices. Requirements for the publication of public notices can be strict and can vary significantly depending on the judicial system of the area in which the publication occurs.

Generally, it is not within the competence of an individual or organization to be aware of specific legal requirements, nor of the best practice format in which a public notice should be published. In the present invention, the device scrutinizes the raw data input received from an applicant user for particular keywords such as bankruptcy, foreclosure, probate for example and ascertains the jurisdiction in which the notice is required to be published.

FIG. 2 illustrates in broad outline the data modification device 100 of the present invention. The device 100 includes computer implemented instructions for automatically modifying raw data input from a user of the device into criteria bound output. Criteria are extracted as data from remote databases maintained by third-party organizations or from local databases maintained by an Operating Entity of the device.

A user 112 makes a request for the generation of a required document for publication through the core of the device, a Public Notice Aggregator 114. The Aggregator 114 acts on the raw data provided by the user, as explained in more detail below, and determines the type of document required. Alternatively, the user nominates the type of document required. The Aggregator 114 then interrogates appropriate databases, 116 and 118 to form the appropriate document/s 120 for publication according to predetermined rule-base criteria.

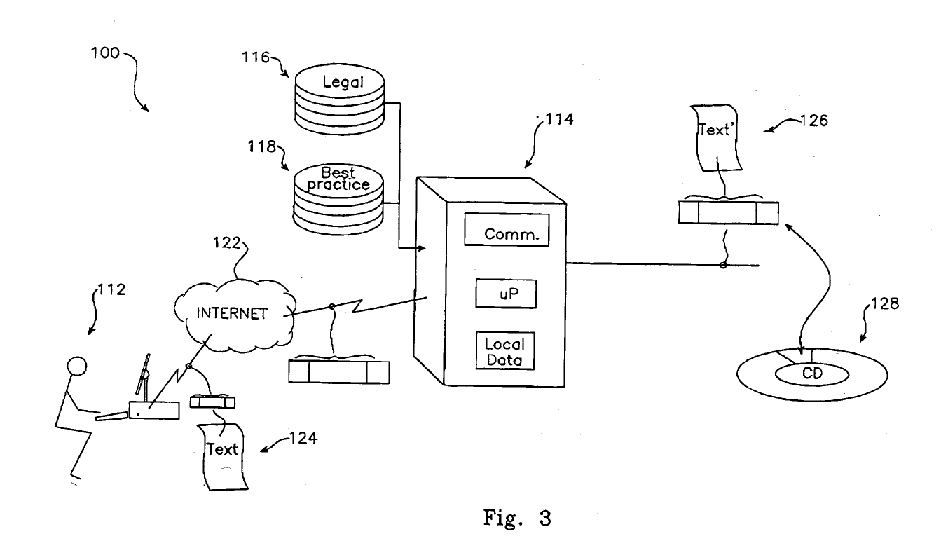

With reference to FIG. 3, the Aggregator 114 of the data modification device 100, includes at least a data input module, a data processing module and a communication module. As well, the device includes an interrogation module for data mining of the relevant predetermined criteria. The data input module is enabled to receive as raw input, data from remote applicant users 112 over a wide area network (WAN) such as the internet 122.

The communication module of the Aggregator 114 provides for the accessing of a selection of databases, either remote third-party databases by means of the WAN or local databases 116 and 118 via a local area network (LAN). These databases can provide the Aggregator 114 with legal and other criteria applicable to the raw data provided by an applicant user 112.

A user 112 submits raw textual data 124 to the Aggregator 114 via the internet 122. The Aggregator 114 firstly analyses the raw textual data 124 to ascertain any characteristics of the data which may require the application of legal or other criteria. This analysis is based on the recognition by algorithms operative within the Aggregator of keywords and groups of keywords. In at least some forms of the present system, the Aggregator 114 may include an automated information gathering facility which provides a user with a number of questions and guidelines to obtain further relevant information missing from the initial user-generated request.

Based on this analysis and any additional data, the Aggregator 114 extracts from the databases 116 and 118 relevant legal and best practice data and applies it to the raw data provided by the client 112 to generate an appropriately structured public notice, either as text 126, to some form of media 128 or to selected publishers.

The notice may be distributed by any of a myriad of modes including but not limited to text, CD, electronic transmission.

Outlets through which distribution may occur is also not to be limited and can include by both print and online publishers of classifieds, public notices and advertisement data.

In addition to data mining the remote databases 116 and 118 maintained by third parties, the Aggregator 114 may have accumulated pro forma public notices based on past requests from users and, where appropriate use such pro forma notices for the generation of a notice specific to the user's situation.

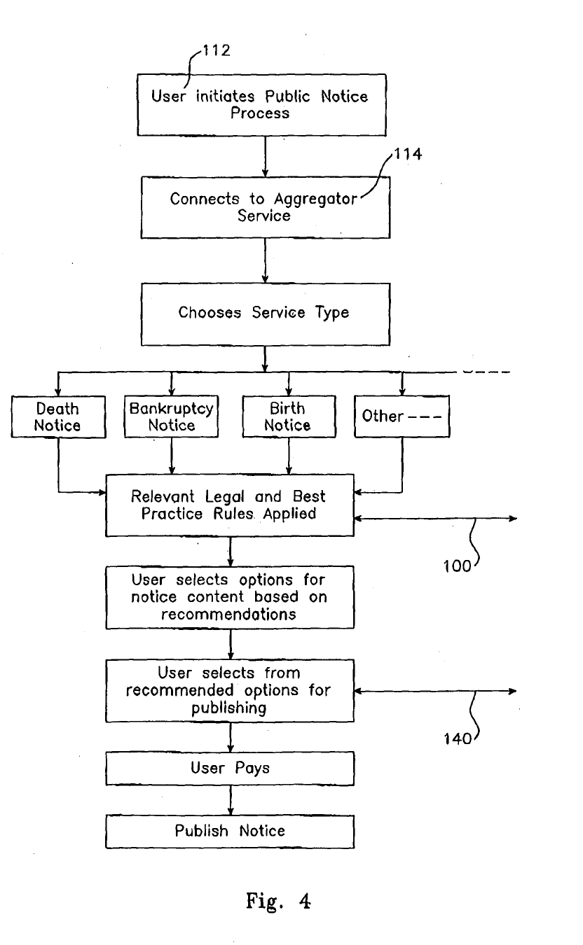

The process is shown schematically in the flow diagram of FIG. 4. The user 112 after initiating a request by connecting to the Aggregator 114, selects the type of public notice to be generated. The selection of the type of public notice to be generated, causes the Aggregator 114 to access and apply relevant legal and best practice rules. Based on these data, the Aggregator may present to the user a number of recommended content options or drafts of legally compliant public notices which the user may select content for inclusion in the notice, or a draft notice.

In a following step, a user may select from a number of recommended publication options. Following payment for service, the data modification system 100 arranges for the notice to be presented for publication to selected publication outlets.

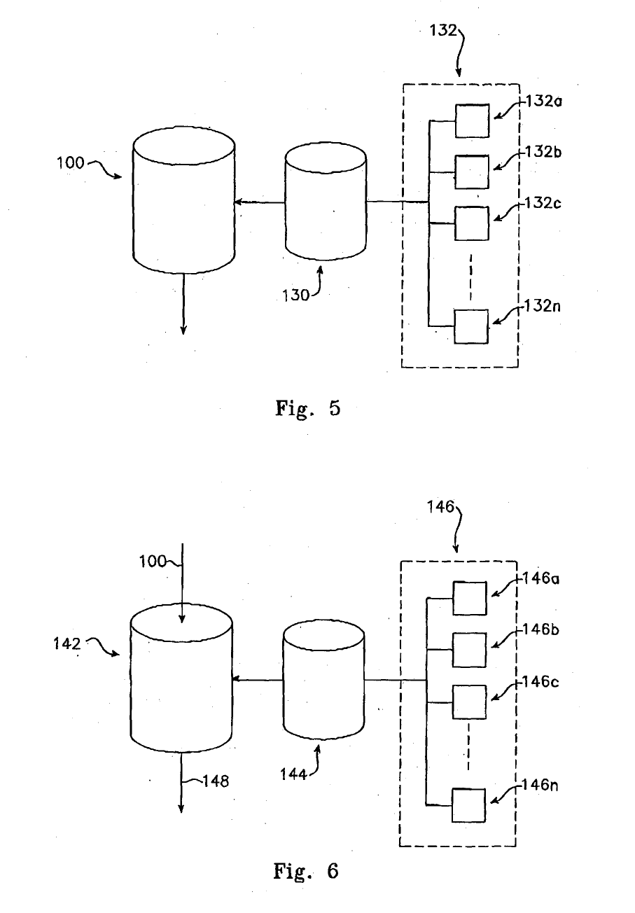

With reference now to FIGS. 5, the Aggregator of the data modification device (100), is fed by a prioritised rule engine (130) which is used to interpret rules 132a to 132n form a rules database 116 and/or 118 for example, and which are used to generate notices that are both legally compliant and conform to accepted best practice. For example, if a user 112 wishes to generate a bankruptcy notice, the Aggregator 114 may be fed with leading questions and recommendations based on a prioritised rule engine 130 which in turn receives relevant legal rules 132, relating for example to bankruptcy notice rules (132a). For example, the correct format and legal name and other legally required identifying elements of the bankrupt entity. This may further include a recommendation for interested persons to contact an administrator where applicable.

The rules 132a to 132n that may be applicable to the various public notices which the Aggregator 114 of the data modification device 100 of the invention is able to generate, include, as noted above, at least legal requirements and best practice guidelines. These rules comprise a series of rules (132) which apply to the full range of public notices that may be generated by the data modification device (100).

FIG. 6 describes a notice distribution recommendation system 140 according to the invention in which a recommendation engine 142 acts following the generation of the notice. Rules 146, regarding the distribution of legal notices of specific types, such as a rule 1116a for a bankruptcy notice, can be used to generate a prioritized list of requirements in a prioritization engine 144. This list is then used to present distribution opportunities to the user 112 for selection.

Also, best practice rules can be applied in addition to rule 146a and can be included for processing through the prioritization engine 144 to become a component of the distribution options being presented to the user 112. The multiple sets of rules 146a to 146n are initially assessed on the bases of the type of notice that is to be distributed and thus is part of the larger set of rules, both legal and best practice. Together these rules are applied to make prioritized decisions about which distribution opportunities can be presented to the user 112. The selected distribution options are then passed on for publication 148.

In another application of the present invention, a user may submit raw data relevant to the advertising of a product or service to the Aggregator of the system and rely on the data modification device and system 100 to both convert that raw data into an appropriately structured classified advertisement and ensure its dissemination to print and on-line media.

In both of the above applications, the data modification device 100 makes available to potential users, web pages into which the raw data may be entered. In each of the above applications, the device acts on the data provided to automatically generate and arrange publication of the appropriate public notice or classified advertisement.

The above describes only some embodiments of the present invention and modifications, obvious to those skilled in the art, can be made thereto without departing from the scope of the present invention.

1. A data modification device; said device including computer implemented instructions for automatically modifying raw data input from a user of said device into criteria bound output; said device including an input receiving Aggregator adapted to interrogate a selection of databases; said Aggregator acting to modify said raw data input with reference to one or more relevant ones of said selection of databases; said device providing to said user output conforming to legal or other appropriate criteria.

2. The device of claim 1 wherein said criteria bound output comprises public notices.

3. The device of claim 1 wherein said criteria bound output comprises advertisements.

4. The device of claim 1 wherein said device includes connectivity to local and wide area communication networks.

5. The device of claim 4 wherein said databases include remote databases maintained by third-party organizations; communication between said device and said databases effected over said wide area network.

6. The device of claim 1 wherein said databases include local databases maintained by an operating entity of said device; communication between said local databases and said device effected over said local communication network.

7. The device of claim previously 1 wherein said user selects a type of public notice from a selection of public notice types made available for generation by said Aggregator.

8. The device of claim 1 wherein said Aggregator applies appropriate legal requirements to said raw data; said legal requirements extracted from a legal requirement rules database.

9. The device of claim 1 wherein said Aggregator applies appropriate best practice requirements to said raw data; said best practice requirements extracted from a best practice requirement rules database.

10. The device of claim 1 wherein said Aggregator presents to said user a selection of options and recommendations relating to content of a said public notice or advertisement.

11. The device of claim 1 wherein said Aggregator presents to said user a selection of options for publishing a said public notice or advertisement.

12. The device of claim 1 for transforming specific input data into data conforming to predetermined criteria; said device including a communication module for receiving said input data and an output module for transmission of modified said input data to a user; said device further provided with an interrogation module for data mining of relevant said predetermined criteria from selected databases.

13. A method of formatting raw input data into criteria bound output data conforming to legal and other requirements; said method including the steps of:
a) Receiving into an Aggregator of a data transforming device raw data from a user,
b) Analysing said data for characteristics requiring application of any of said legal or other criteria,
c) Interrogating appropriate databases containing said legal or other criteria,
and wherein said device automatically modifies said raw input data into a format conforming to said legal and other requirements.

14. The method of claim 13 wherein said raw input data is data relating to public notice bound by legal requirements.

15-16. (canceled)

17. A method for producing a legally compliant public notice for a client user; said method including the steps of:
a) Receiving into an Aggregator of a data transforming device raw data from a user,
b) Analysing said data for characteristics requiring application of any of said pre-determined criteria,
c) Interrogating appropriate databases containing said pre-determined criteria,
and wherein said device automatically modifies said raw input data into a format conforming to said pre-determined criteria.

18-30. (canceled)

31. The media of claim 17 wherein said raw input data is data relating to public notice bound by legal requirements.

32-34. (canceled)
